(19) United States
(12) Patent Application Publication
(10) Pub. No.: US 2012/0019900 A1
(43) Pub. Date: Jan. 26, 2012

(54) LIGHT DIFFUSERS AND DISPLAYS COMPRISING SAME

(76) Inventors: Stephen Kitson, Bristol (GB); Adrian Geisow, Portishead (GB)

(21) Appl. No.: 13/260,250

(22) PCT Filed: Jul. 7, 2009
(86) PCT No.: PCT/US09/49839

§ 371 Date: Sep. 23, 2011

(51) Int. Cl. G02F 1/167; B05D 5/06; G02B 5/02

(52) U.S. Cl. 359/296; 359/599; 427/162

(57) ABSTRACT

A light diffuser (20, 46) includes a plurality of fiber-like features (24) disposed in a filler (26) in a two-dimensional array. The features (24) have a longitudinal axis and are substantially parallel to one another. A refractive index of the features (24) is different from a refractive index of the filler (26). The features (24) are either a polymeric solid or a liquid. The filler (26) is substantially solid when features (24) are liquid. When the features (24) are a polymeric solid, at least one feature (24) of the plurality includes at least one predetermined variation in one or both of a longitudinal cross-sectional dimension and a horizontal cross-sectional dimension.

### CROSS-REFERENCE TO RELATED APPLICATIONS

N/A

### STATEMENT REGARDING FEDERALLY SPONSORED RESEARCH OR DEVELOPMENT

N/A

### BACKGROUND

It is known in the art to combine fiber optic faceplates with Liquid Crystal Display (LCD) systems. Examples of such combinations are described in U.S. Pat. No. 4,349,817 to Hoffman, et al. (Hoffman) and U.S. Pat. No. 5,035,490 to Hubby. Major advantages of displays that employ liquid crystal layers include their compact, rugged construction and their portability as display screens for portable personal computers.

A reflective display uses ambient light to illuminate the image rather than a backlight. The display consists of one or more electro-optic layers on top of a reflector. If the reflector is specular, then it is hard to get a clear image; the viewer either sees themselves or a strong glare reflection from the front surface. To address this problem, the display should have a diffuser element to spread the light over a range of angles of incidence and thereby widen the viewing angle. The diffuser can either be at the back of the display, immediately before, or part of, the reflector; or the diffuser can be on the front surface.

As explained above, displays generally need a diffuser to give a bright image with a wide viewing angle. For reflective displays one approach is to have a diffuser on the front surface of the display. Hoffman teaches the application of a fiber plate composed of fibers each having as low numerical aperture as possible and restricting the viewing angle by means of the black interstitial material as much as possible in order to reject as much stray light as possible. In contrast, Hubby teaches the application of fiber plates having as high a numerical aperture as possible and permitting as wide a viewing angle as possible in order to gather as much ambient light as possible to illuminate the display. However glass fiber faceplates are not easy or inexpensive to fabricate.

### BRIEF DESCRIPTION OF THE DRAWINGS

The drawings provided herein are not to scale and are provided for the purpose of facilitating the understanding of certain embodiments of the present invention and are provided by way of illustration and not limitation on the scope of the appended claims.

FIG. 1A is a two-dimensional depiction of the light scatter pattern for a conventional diffuser.

FIG. 1B is a three-dimensional depiction of the same light scatter pattern as shown in FIG. 1A for a conventional diffuser.

FIG. 2A is a two-dimensional depiction of the light scatter pattern for a light diffuser in accordance with embodiments of the present invention.

FIG. 2B is a three-dimensional depiction of the same light scatter pattern as shown in FIG. 2A for a light diffuser in accordance with embodiments of the present invention.

FIG. 3 is a three-dimensional depiction of an embodiment of a fiber-like feature in accordance with embodiments of the present invention.

FIG. 4 is a cross-sectional view of an embodiment of a fiber-like feature in accordance with embodiments of the present invention.

FIG. 5A illustrates in macroscale a schematic of an embodiment of a diffuser in accordance with an embodiment of the present invention.

FIG. 5B illustrates in macroscale a schematic of an embodiment depicting a support layer having disposed thereon fiber-like features and voids between the features in the initial steps of the preparation of a diffuser in accordance with an embodiment of the present invention shown in FIG. 5A.

FIG. 5C illustrates in macroscale a schematic of an embodiment depicting a support layer having disposed thereon substantially solid filler with voids between the filler in the initial steps of the preparation of a diffuser in accordance with an embodiment of the present invention shown in FIG. 5A where the voids subsequently are filled with liquid to form the fiber-like features.

FIG. 6 illustrates a schematic of an embodiment of a reflective display in accordance with an embodiment of the present invention.

FIG. 7 illustrates a schematic of another embodiment of a reflective display in accordance with an embodiment of the present invention.

FIG. 8 is a flow chart illustrating an embodiment of a method in accordance with an embodiment of the present invention.

### DETAILED DESCRIPTION

Some embodiments of the present invention are directed to a light diffuser, which comprises a plurality of fiber-like features disposed in a filler in a substantially two-dimensional array. The features have a longitudinal axis and are substantially parallel to one another. A refractive index of the features is different from a refractive index of the filler. Features are a polymeric solid or a liquid. The filler is substantially solid when the features are liquid; and, when the features are a polymeric solid, at least one feature of the plurality comprises at least one predetermined variation in one or both of a longitudinal cross-sectional dimension and a horizontal cross-sectional dimension.

Some embodiments of the present invention are directed to a light diffuser, which comprises a transparent non-polarizing support layer. The support layer has disposed on a surface of the support layer a plurality of fiber-like features that extend from the surface and are disposed in a two-dimensional array. The features each have a longitudinal axis that is substantially parallel to one another and there is at least one predetermined variation in a longitudinal or horizontal cross-sectional dimension or both of at least one feature. A filler is disposed between the features wherein the filler has a refractive index different from a refractive index of the polymer features. In some embodiments the features and the filler lie between the transparent substrate and the support layer.

Some embodiments of the present invention are directed to a visual image display apparatus comprising a light diffuser as described above. In some embodiments the visual image display apparatus further comprises an electro-optic layer and a reflector that reflects light received from the rear of the electro-optic layer back through the electro-optic layer. In some embodiments the light diffuser is disposed in front of the electro-optic layer.

Some embodiments of the present invention are directed to a visual image display apparatus comprising a liquid crystal layer having a front and back surface, a front orientation layer adjacent to the front surface of the liquid crystal layer, a back orientation layer adjacent to the back surface of the liquid crystal layer, a front transparent electrode adjacent to the front orientation layer, a rear transparent electrode adjacent to the rear orientation layer, a reflector that reflects light received from the rear of the liquid crystal layer back through the liquid crystal layer, and a light diffuser in front of the electro-optic layer. The light diffuser comprises a transparent non-polarizing support layer and a transparent substrate, which in some embodiments is non-polarizing. The support layer has disposed on a surface of the support layer a plurality of fiber-like features that extend from the surface in a two-dimensional array. The fiber-like features are a polymeric solid or a liquid. The features each have a longitudinal axis that is substantially parallel to one another. When the features are a polymeric solid, there is at least one predetermined variation in a longitudinal or horizontal cross-sectional dimension or both of at least one feature. A filler is disposed between the features wherein the filler has a refractive index different from a refractive index of the polymer features. When the features are liquid, the filler is substantially solid. The features have a shape and a length such that light impinging on the light diffuser at an angle is diffused into a hollow cone centered about a normal to the light diffuser. The features and the filler are disposed between the transparent substrate and the support layer.

Some embodiments of the present invention are directed to methods of making the light diffuser described above. In some embodiments, the method comprises (a) preparing a master structure wherein the master structure has a plurality of fiber-like master features extending from a surface of a substrate, the features having a longitudinal axis and being substantially parallel to one another, at least one feature of the plurality comprising at least one predetermined variation in one or both of a longitudinal cross-sectional dimension and a horizontal cross-sectional dimension, (b) preparing an inverse copy of the master structure, (c) applying a liquid polymer-precursor material to a surface of a transparent non-polarizing support layer, (d) pressing the inverse copy of the master structure into the liquid polymer-precursor material, (e) polymerizing the liquid polymer-precursor material to form a solid polymer of fiber-like features, (f) removing the inverse to copy of the master structure from the solid polymer to produce voids between the fiber-like features, (g) applying a filler material to fill the voids, and (h) attaching the transparent substrate to cover the filler and the fiber-like features. In some embodiments where the filler material is curable, the method further comprises (i) curing the filler material to form the filler.

The fiber-like features disposed on a support layer in accordance with embodiments of the present invention are more easily manufactured than known light diffusers such as those disclosed in Hubby. The fiber-like features of embodiments of the present light diffuser may be manufactured over relatively large areas and more control over the optical properties of the light diffuser is realized. The shapes of the individual features can be controlled in their cross-sectional dimension to achieve certain advantageous properties such as, for example, an effect of a refractive index gradient between the features and the filler. In some embodiments the filler may have a refractive index gradient so that the index of mismatch is greater on one side of the filler layer than on the other side of the filler layer. Such a situation provides the opportunity for tuning the scattering properties of the layer and may assist in reducing back-scatter from the diffuser.

An electro-optic layer is a layer with optical properties that can be modulated through application of a voltage. Examples of materials of which the electro-optic layer may be comprised include, by way of illustration and not limitation, liquid crystal materials, suspensions of electrophoretic pigments, cholesteric materials, microelectromechanical (MEMS) materials and dichroic guest host liquid crystals. The nature of the electro-optic layer determines the type of display, for example, liquid crystal displays, electrophoretic displays, cholesteric displays, MEMS-based displays, dichroic guest host displays and electro-wetting displays.

In some embodiments the light diffuser of the present invention is a front diffuser employed with reflective displays. The front diffuser diffuses light on the way into the display as well as on the way back out to the viewer. As such, it gives an opportunity to control the path taken by the light on both passages through the electro-optic layer. This characteristic permits optimization of the brightness of a display. Embodiments of the present light diffuser allow for impinging light to be substantially forward scattered. This may be advantageous because any back scatter results in the scatter of part of the incident light back to the viewer before it has been modulated by the electro-optic layer(s). The substantially forward scatter avoids the reduction in the contrast and the washing out of color that is observed with back scatter. In embodiments of the present light diffuser, light scatter may be held within a controlled range of incident polar angles measured with respect to the walls of a visual display that includes the present light diffuser. If the light is scattered outside of the controlled range, it may be beyond the critical angle for total internal reflection and, therefore, does not escape to the viewer. This reduces the brightness of the display. Scattering at angles within a controlled range also decreases the path length in the display, which can enhance brightness of the display significantly. The aforementioned considerations are particularly relevant for dye guest host displays.

Embodiments of the present invention find use in LCDs that are intended for use in portable systems. Such systems should be of the reflection type in order to make use of available ambient light for illumination rather than incurring the weight, bulk and power consumption characteristic of active backlighting. Such displays include a liquid crystal layer which is sandwiched between transparent front and back electrodes, and a specular or semi-specular (i.e., mirror-like) surface placed behind the display. The system has an off-state, i.e., no voltage is applied between the front and back electrodes, and an on-state, i.e., voltage is applied between the front and back electrodes. Embodiments of the present invention further the provision of displays that are optically efficient enough to give bright vivid images with just ambient illumination.

As mentioned above, embodiments of a light diffuser in accordance with the present invention comprise a support layer that is transparent and non-polarizing. Transparent means that the support layer has the property of transmitting rays of light through its substance so that the support layer can be seen through; the term includes translucent. The term “transparent” means allowing at least 50%, or at least 55%, or least 60%, or at least 65%, or at least 70%, or at least 75%, or at least 80%, or at least 85%, or at least 90%, or at least 95%, or at least 99%, for example, of incident light in the visible wavelength range to be transmitted.

Non-polarizing means that the support layer does not exhibit to any significant degree properties of a polarizer, i.e., the transmission of light through the support layer is substantially the same for any polarization of light. The phrase “substantially the same” means that the transmission of light through the support layer for any polarization of light does not differ by more than about 10%, or more than about 5%, or more than about 4%, or more than about 3%, or more than about 2%, or more than about 1%, or more than about 0.5%, or more than about 0.1%, for example.

The composition of the support layer may be an organic or inorganic, water-insoluble solid material. The support layer may be, for example, glass, natural or synthetic polymer, either alone or in conjunction with other materials. The polymers include, for example, polyvinyl chloride, polyacrylamide, cross-linked dextran, agarose, polyacrylate, polyethylene, polypropylene, poly(4-methylbutene), polystyrene, polymethacrylate, polyethylene terephthalate, nylon, polyvinyl butyrate, nitrocellulose and cellulose acetate.

In some embodiments the support layer is substantially planar with a thickness of about 0.02 to about 1 mm, or about 0.02 to about 0.8 mm, or about 0.02 to about 0.6 mm, or about 0.02 to about 0.4 mm, or about 0.02 to about 0.2 mm, or about 0.02 to about 0.1 mm, or about 0.05 to about 1 mm, or about 0.05 to about 0.5 mm, or about 0.05 to about 0.2 mm, or about 0.05 to about 0.1 mm.

A surface of the support layer comprises a plurality of fiber-like features. The term “fiber-like” as used herein means an elongated structure that functions like an optical fiber to guide an optical signal. In some embodiments the surface that comprises the features lies in the plane of the support layer corresponding to its greatest dimension and the features extend from the surface in a two-dimensional array. The term “array” means an arrangement of objects; in some embodiments, a systematic arrangement of objects; in some embodiments, a systematic arrangement of objects in rows and columns.

In some embodiments, the features each have a longitudinal axis that is substantially parallel to one another. By the phrase “substantially parallel” is meant that the longitudinal axis of the features do not vary from parallel arrangement by more than about 20 degrees, or by no more than about 15 degrees, or by no more than about 10 degrees, or by no more than about 5 degrees, or by no more than about 4 degrees, or by no more than about 3 degrees, or by no more than about 2 degrees, or by no more than about 1 degree, for example. In some embodiments the features are substantially normal to the surface of the support layer. In some embodiments the features are inclined at an angle from the surface. In some embodiments the angle is about 60 to about 85 degrees, or about 60 to about 80 degrees, or about 60 to about 75 degrees, or about 60 to about 70 degrees, or about 70 to about 85 degrees, or about 75 to about 85 degrees, or about 80 to about 85 degrees, for example.

As mentioned above, there is at least one predetermined variation in a longitudinal or horizontal cross-sectional dimension or both of at least one feature in embodiments of the present light diffuser. The term “predetermined” means that the variation is designed rather than, for example, being an artifact or a defect of a manufacturing process. The phrase “variation in longitudinal cross-sectional dimension” as used herein refers to a difference in the length between at least two imaginary lines extending through the feature at two different positions along the longitudinal axis wherein the imaginary line extends through the feature perpendicular to the longitudinal axis of the feature. This variation may be periodic, or have a periodic component. The pitch of the periodic component in the variation will be less than the wavelength of light in either medium, often less than about one half the wavelength, and typically close to about one quarter the wavelength in the media. The number of repeats will probably be less than 20 and more than 1. The number of variations is at least 2, or at least 3, or at least 4, or at least 5, or at least 6, or at least 7, or at least 8, or at least 9 or at least 10, for example. The number of variations is in the range of about 2 to about 15, or about 2 to about 10, or about 2 to about 5.

The phrase “variation in horizontal cross-sectional dimension” as used herein refers to a difference in the length between at least two imaginary lines extending through the feature at the same position along the longitudinal axis wherein the imaginary line extends through the feature perpendicular to the longitudinal axis of the feature. The number of variations is used to tune index matching and light scattering. In some embodiments the number of variations is less than about 50 variations, or less than about 40, or less than about 30, or less than about 20, or less than about 15, or less than about 10, for example. In some embodiments the number of variations is at least 2, or at least 3, or at least 4, or at least 5, or at least 6, or at least 7, or at least 8, or at least 9 or at least 10, for example. In some embodiments the number of variations is in the range of about 2 to about 15, or about 2 to about 10, or about 2 to about 5.

In some embodiments the cross-sectional shape of the features may be circular with at least one variation in the longitudinal cross-sectional dimension. In some embodiments, where there is a variation in horizontal cross-sectional dimension, the cross-sectional shape may be polygonal, such as triangular, square, quadrangular, hexangular, or oval, scalloped, ellipsoidal, corrugated, or star-shaped with different numbers of vertices, for example. In general, the cross-sectional shape and dimensions of the fiber-like features are dependent on a number of factors that include, for example, optimization of the guiding and scattering of emerging light.

In some embodiments the features may be shaped to optimize the guiding and the scattering of the emerging light. For example, by tapering the fiber-like features out slightly, emerging light would come out over a narrower cone of angles. In some embodiments the longitudinal cross-sectional dimension of the fiber-like features may be varied such that the features are tapered resulting in a shape that is, for example, pyramidal, hour-glassed, bulbous, conical. For example, a longitudinal cross-sectional dimension of a feature at the point of attachment to the support layer may be greater or less than a cross-sectional dimension at or near the opposing end of the feature and/or at or near a point that is equidistant between the two.

In some embodiments the cross-sectional dimension of the fiber-like features may be varied at more that one location along the feature. In some embodiments, the cross-sectional dimension of a feature may vary by about 5 to about 50%, or about 5 to about 40%, or about 5 to about 30%, or about 5 to about 25%, or about 5 to about 20%, or about 10 to about 50%, or about 10 to about 40%, or about 10 to about 30%, or about 10 to about 25%, or about 10 to about 20%, for example. In some embodiments, for a variation in the longitudinal cross-sectional dimension, the slope of a wall of the feature in at least one position along the wall does not vary from the longitudinal axis by more than 10 degrees, or by more than 9 degrees, or by more than 8 degrees, or by more that 7 degrees, or by more than 6 degrees, or by more than 5 degrees, or by more than 4 degrees, or by more than 3 degrees, or by more that 2 degrees, or by more than 1 degree, for example. In some embodiments, at least two longitudinal cross-sectional dimensions are substantially the same.

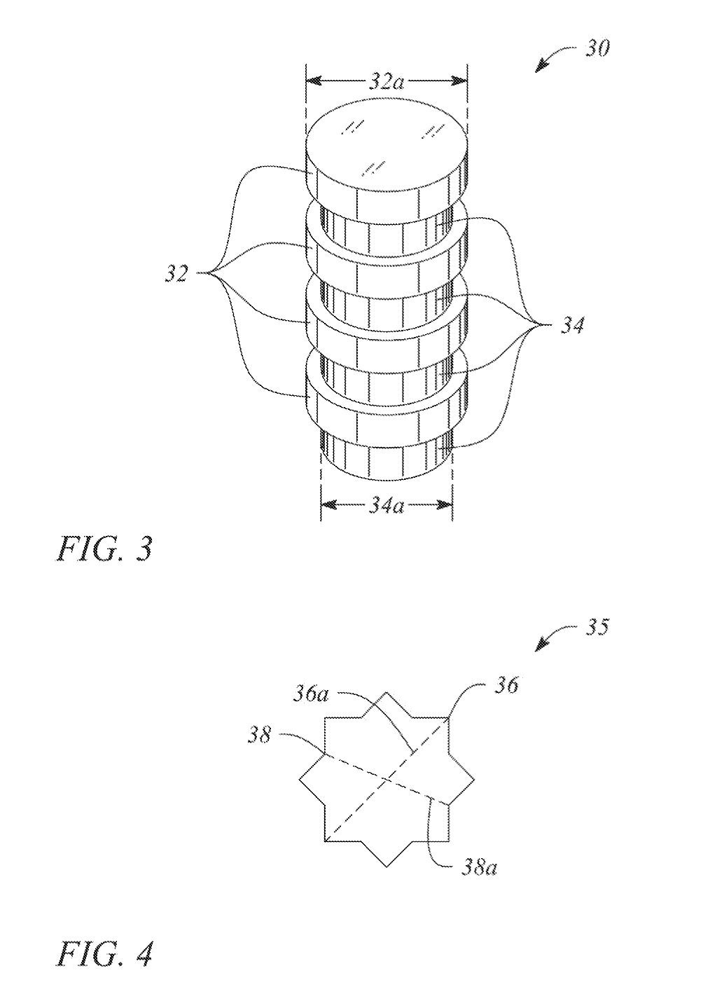

An example of a fiber-like feature in accordance with an embodiment of a feature that exhibits variations in longitudinal cross-sectional shape is depicted in FIG. 3 by way of illustration and not limitation. Fiber-like feature 30 comprises four cylindrical subfeatures 32 having a longitudinal cross-sectional dimension 32a greater than longitudinal cross-sectional dimension 34a of four cylindrical subfeatures 34. In the embodiment shown, if the thickness of each subfeature is equal to one quarter the wavelength of light impinging on feature 30, then the feature will preferentially reflect and scatter that wavelength of light. In this way, color may be introduced into a light diffuser comprising feature 30, which may be useful in applications involving displays, for example.

An example of a fiber-like feature in accordance with an embodiment of a feature that exhibits variations in horizontal cross-sectional dimension is depicted in FIG. 4 by way of illustration and not limitation. Scalloped fiber-like feature 35 comprises eight variations 36 of equal length in one horizontal cross-sectional dimension 36a and eight variations 38 of equal length in another horizontal cross-sectional dimension 38a where the length in variations 36 is greater than the length in variations 38. In the embodiment shown, light scattering may be increased depending on the size of the scallops (the length of variations 36 versus the length of variations 38). The scalloping may also be employed to give the effect of a refractive index gradient between the feature and the filler if the scalloping/corrugation in the cross-section is sub-wavelength. Such an index gradient is advantageous in controlling the guiding of light through the feature as is known from optical fiber technology.

The guiding of light emerging from the light diffuser may also be enhanced by coating the polymer features with a thin layer of reflective metal. Examples of suitable reflective metals include, by way of illustration and not limitation, nickel, silver and aluminum. The thickness of the metal coating should be sufficient to enhance reflectivity but not so great as to result in a substantial reduction of the aperture. In some embodiments the thickness of the metal coating is about 20 to about 300 nm, or about 20 to about 250 nm, or about 20 to about 200 nm, or about 50 to about 300 nm, or about 50 to about 250 nm, or about 50 to about 200 nm, or about 100 to about 200 nm, for example. The metal may be applied to the outer surface of the features by methods such as, for example, sputter coating, plating and evaporation.

In some embodiments the cross-sectional dimension for each variant of the cross-sectional dimensions of the fiber-like features may be less than about 100 microns, or less than about 50 microns, or less than about 30 microns, or less than about 20 microns, for example, and greater than about 1 micron, or greater than about 5 microns, for example. The cross-sectional dimension for each variant of cross-sectional dimension of the features in some embodiments may be in the range of about 1 to about 100 microns, or about 1 to about 50 microns, or about 1 to about 30 microns, or about 1 to about 20 microns, or about 1 to about 10 microns, or about 5 to about 100 microns, or about 5 to about 50 microns, or about 5 to about 30 microns, or about 5 to about 20 microns, or about 5 to 10 microns, or about 10 to about 100 microns, or about 10 to about 50 microns, or about 10 to about 30 microns, or about 10 to about 20 microns, or about 8 to about 12 microns, for example.

In some embodiments, the length of the fiber-like features may be in the range of about 1 to about 100 microns, or about 1 to about 50 microns, or about 1 to about 30 microns, or about 1 to about 20 microns, or about 1 to about 10 microns, or about 5 to about 100 microns, or about 5 to about 50 microns, or about 5 to about 30 microns, or about 5 to about 20 microns, or about 5 to 10 microns, or about 10 to about 100 microns, or about 10 to about 50 microns, or about 10 to about 30 microns, or about 10 to about 20 microns, for example.

In some embodiments the composition of the fiber-like features is a polymeric solid, which includes semi-solids or quasi-solids. Suitable polymers include, for example, polyvinyl chloride, polyacrylamide, cross-linked dextran, agarose, polyacrylate, polyethylene, polypropylene, poly(4-methylbutene), polystyrene, polymethacrylate, polyethylene terephthalate, nylon, polyvinyl butyrate, nitrocellulose and cellulose acetate or a combination of two or more of the above. As with the support layer, the features are transparent. As is evident from the above, the term “polymeric solid” does not include glass or a solely glass material (such as, e.g., glass fibers) although glass-polymeric solid combinations could be employed in some embodiments.

In some embodiments the composition of the fiber-like features is liquid, which may be non-polymeric or polymeric. Suitable liquids are those that exhibit a relatively high index of refraction such as, for example, an index of refraction of about 1.6 to about 1.8, or about 1.6 to about 1.7, or about 1.7 to about 1.8, for example. A suitable liquid for the fiber-like features should be, for example, stable (including good photostability) and colorless. Examples of suitable liquids, by way of illustration and not limitation, iodinated methanes (e.g., diiodomethane), refractive index liquids in the refractive index range of about 1.6 to about 1.8 sold by Cargille Labs (Cedar Grove N.J.), for example. Glass is not included within the definition of “liquid” as the term is used herein.

The spacing of the fiber-like features on the surface of the support layer is dependent, for example, on the width of the fiber-like features. In some embodiments that spacing is in the range of about 10% to about 200%, or about 10% to about 150%, or about 10% to about 125%, or about 50% to about 200%, or about 50 to about 150%, or about 50% to about 125%, or about 75% to about 200%, or about 75 to about 150%, or about 75% to about 125%, or about 90% to about 110%, or about 100% of the width of the fiber-like features, for example.

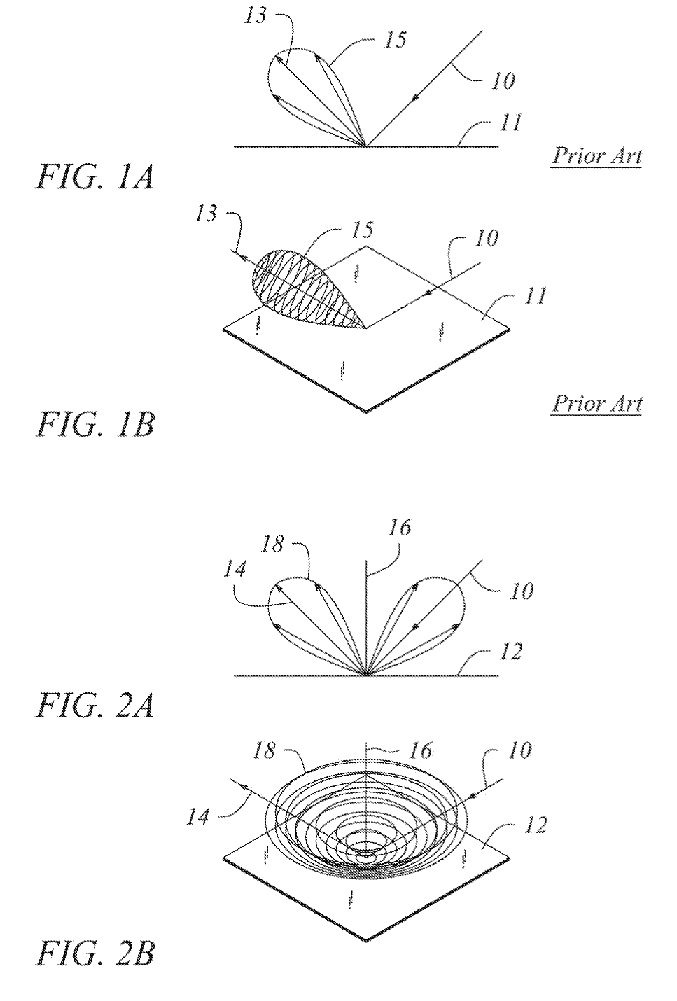

FIGS. 1A and 1B show the light scattering pattern for a conventional diffuser. As can be seen, a conventional diffuser scatters light 10 impinging on surface 11 such that its energy is distributed within a cone centered on the direction 13 of the specular beam 15. A conventional diffuser, therefore, scatters the light within a cone centered around the specular direction. Such diffusers include a rough surface or a film with random inclusions with different refractive indices. As a result, light incident at high polar angles may well be scattered at high angles and be lost rather than reaching the viewer. In addition, the reflected light will only be visible within a narrow set of viewing directions. This can be broadened by tuning the diffuser to scatter light over a wider range of angles, but that also tends to increase the amount of back-scatter.

The fiber-like features in a light diffuser in accordance with the present embodiments have a shape and a length, as well as a population and angle of inclination, such that light impinging on the light diffuser at an angle is diffused into a hollow cone centered about a normal to the light diffuser. The light diffusion pattern for a light diffuser in accordance with the present embodiments is depicted in FIGS. 2A and 2B. As can be seen with reference to the figures, light 10 impinging at a certain angle on to the surface 12 of embodiments of the present light diffuser is diffused into a hollow cone 14 centered around the normal 16 to the surface of the light diffuser rather than centered on the specular direction 18.

There is at least one difference between a conventional diffuser and the situation shown in two dimensions in FIG. 2A and in three dimensions in FIG. 2B. The volume representing the intensity of light scattered at a given angle is now an article of revolution about the normal to the display surface, not about the direction of specular reflection. This means that light from a given ambient source is spread over a much larger far field angle than in the case of the conventional diffuser and also that ambient light from a larger variety of directions can contribute to the illumination apparent to a given viewer than in the case of the conventional diffuser. Furthermore, the viewer need not be close to a position that would cause light reflected in the specular direction to fall in his eyes in order to see the display brightly illuminated.

As mentioned above, the surface with fiber-like features comprises a filler between the features. The filler has a refractive index different from a refractive index of the fiber-like features. As may be understood, the amount of filler is dependent on the number of features, the cross-sectional dimension of the features, for example. As with the support layer, the filler is also transparent. In some embodiments, the filler may be a solid, a liquid (including oils) or a gas. Some filler materials such as oils and gasses are non-curable materials whereas some liquid filler materials are curable and require a curing step. Examples of fillers that may be employed include, for example, resins, oils and gases. Suitable resins may be synthetic or naturally-occurring and include, for example, thermoplastic materials such as, e.g., polyvinyl, polystyrene, polyethylene, thermosetting materials such as, e.g., polyesters, epoxies, silicones, UV curable polymers such as, for example, acrylates. Oils that may be employed as the filler include, for example, silicone oil. Gases that may be employed include, for example, air, nitrogen, a noble gas (argon, neon, helium, etc.).

As mentioned above, when the fiber-like features are liquid, the filler is substantially solid. The term “substantially solid” includes solid and quasi-solid (semi-solid) materials and means that the filler is solid to an extent that the structure and shape of features that are liquid is maintained and/or that the solid or quasi-solid filler can hold its own size and shape and has little or no tendency to flow under moderate stress at the temperatures under which a device comprising the present light diffuser is used.

For solid fillers the refractive index may be in the range of about 1.3 to about 1.8, or about 1.3 to about 1.7, or about 1.3 to about 1.6, or about 1.3 to about 1.5, or about 1.4 to about 1.7, or about 1.4 to about 1.6, for example. For liquid fillers the refractive index may be in the range of about 1.2 to about 1.8, or about 1.2 to about 1.7, or about 1.2 to about 1.6, or about 1.2 to about 1.5, or about 1.2 to about 1.4, or about 1.3 to about 1.7, or about 1.3 to about 1.6, or about 1.3 to about 1.5, or about 1.4 to about 1.7, or about 1.4 to about 1.6, for example. For gas fillers the refractive index is about 1, for example.

As mentioned above, the refractive indices of the fiber-like features and the filler are different. The magnitude of the difference in the refractive indices is dependent on a number of factors including, for example, the composition of the features and the composition of the filler. The difference between the refractive indices should be sufficient to obtain suitable light scattering when light impinges on the diffuser. The refractive index of the fiber-like features may be in the range of about 1.4 to about 1.6, for example. In some embodiments the numerical difference between the refractive indices is about 0.02 to about 0.8 (where, for example, air is the filler), or about 0.02 to about 0.5, or about 0.02 to about 0.1, or about 0.05 to about 0.8, or about 0.05 to about 0.5, or about 0.05 to about 0.1, or about 0.08 to about 0.5, or about 0.08 to about 0.1, for example. In some embodiments the refractive index of the fiber-like features is greater than the refractive index of the filler.

As mentioned above, is some embodiments the features and the filler are disposed between a transparent substrate and the support layer. The transparent substrate, in some embodiments, has characteristics such as composition, dimensions, thermal expansion coefficients, rigidity, tensile strength, for example, which are substantially similar to those of the support layer. In some embodiments the transparent substrate is non-polarizing. The composition of the transparent substrate may be an organic or inorganic, water-insoluble solid material. The transparent substrate may be, for example, glass, natural or synthetic polymer, either alone or in conjunction with other materials. The polymers include, for example, polyvinyl chloride, polyacrylamide, cross-linked dextran, agarose, polyacrylate, polyethylene, polypropylene, poly(4-methylbutene), polystyrene, polymethacrylate, polyethylene terephthalate, nylon, polyvinyl butyrate, nitrocellulose and cellulose acetate.

In some embodiments the transparent substrate is substantially planar with a thickness of about 0.02 to about 1 mm, or about 0.02 to about 0.8 mm, or about 0.02 to about 0.6 mm, or about 0.02 to about 0.4 mm, or about 0.02 to about 0.2 mm, or about 0.02 to about 0.1 mm, or about 0.05 to about 1 mm, or about 0.05 to about 0.5 mm, or about 0.05 to about 0.2 mm, or about 0.05 to about 0.1 mm.

In some embodiments the support layer is attached to a transparent support. The composition of the transparent support may be selected from the same materials from which the composition of the transparent substrate is selected. The transparent support and the transparent substrate may have the same or different composition. As with the transparent substrate, the transparent support is non-polarizing. The support layer may be attached to the transparent support by techniques such as, for example, lamination. The support layer may be attached to a surface of the transparent support prior to or after the attachment of the fiber-like features to the surface of the support layer.

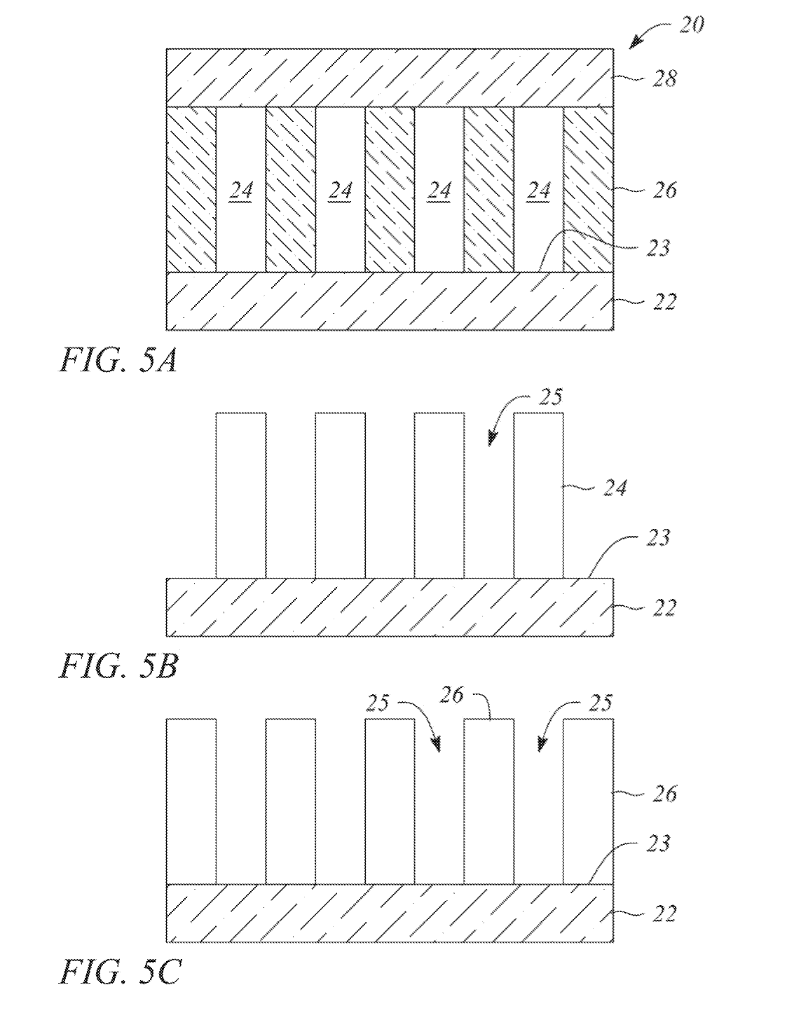

FIG. 5A depicts in macroscale a portion of an embodiment of a light diffuser in accordance with an embodiment of the present invention by way of illustration and not limitation. Light diffuser 20 comprises support layer 22 having on surface 23 thereof fiber-like features 24. Between the features 24 is filler 26 having a refractive index that is different than the refractive index of features 24. Transparent substrate 28 lies transverse to features 24.

A light diffuser in accordance with embodiments of the present invention may be produced in a number of ways. For example, the fiber-like features themselves may be fabricated by known processes such as, for example, one or more of optical lithography, extrusion, molding, casting, imprinting, embossing and e-beam lithography. In some embodiments optical lithography may be employed to replicate a pattern of fiber-like features rapidly from support layer to support layer. The lithographic system includes, for example, an exposure tool, mask and resist for transferring a pattern from a mask to a resist and then to the support layer. The process is similar to that employed in the electronics industry for the preparation of chips, wafers, integrated circuits and the like using thin-film technology. In some embodiments a polymer-precursor material from which the fiber-like features are formed is applied to the surface of the support layer by, for example, spin coating, printing, casting, slot die coating, gravure coating, reverse roll coating, gap coating, use of a metering rod, immersion coating, curtain coating. The polymer-precursor material is a monomeric material or an oligomeric material that is polymerized by application of light or heat, for example, and, thus, may also be referred to as a curable material. In some embodiments, the polymer-precursor material may be a photoresist material, either a positive or a negative photoresist. The thickness of the resultant polymer film corresponds to the length of the resultant fiber-like features. The surface of the polymer film is then treated to produce the features. In some embodiments imprinting is utilized to produce the features. In such embodiment imprinting may be accomplished by exposure to UV light, to a source of radiation, for example.

In the manufacture of diffuser 20, according to some embodiments, a thin layer or film of polymer-precursor material is adhered to surface 23 of support layer 22. The polymer-precursor material may be a photoresist material, which in this embodiment is a negative photoresist and may be subjected to UV curing. A mask is overlaid on the photoresist; the mask is UV transparent and comprises a pattern of transparent areas surrounded by opaque regions that correspond to the voids. UV light is impinged on the exposed surface of the mask. The UV light cures the photoresist corresponding to fiber-like features 24 but does not cure the photoresist corresponding to the voids. Following the UV curing, support layer 22 is treated to remove unexposed photoresist material. FIG. 5B illustrates fiber-like features 24 on surface 23 of support layer 22 and the voids between features 24 in the manufacture of the light diffuser, according to some embodiments. During the fabrication process, various heating steps may be employed at various stages of the process. For example, heating steps may be employed after the application of the photoresist, after the UV curing step, after removal of the uncured photoresist, for example. The temperature and duration of heating for each stage depends on the nature of the photoresist, for example. Such parameters are normally supplied by the manufacturer of the polymeric material, which, as mentioned above, is a photoresist in the exemplary embodiment discussed above.

Following the creation of fiber-like features 24 and voids 25 on support layer 22, a suitable filler 26, or filler precursor material that will become the filler 26, is introduced into voids 25. The manner of introduction depends on the nature of the filler, for example. In some embodiments, the filler precursor is a curable filler material such as, for example, a resin. The resin is introduced into voids 25 and transparent substrate 28 is placed over the resin, which is then treated under conditions for curing the resin. The conditions are dependent on the nature of the resin, for example. Examples of other filler precursors include acrylate or epoxy monomers, for example.

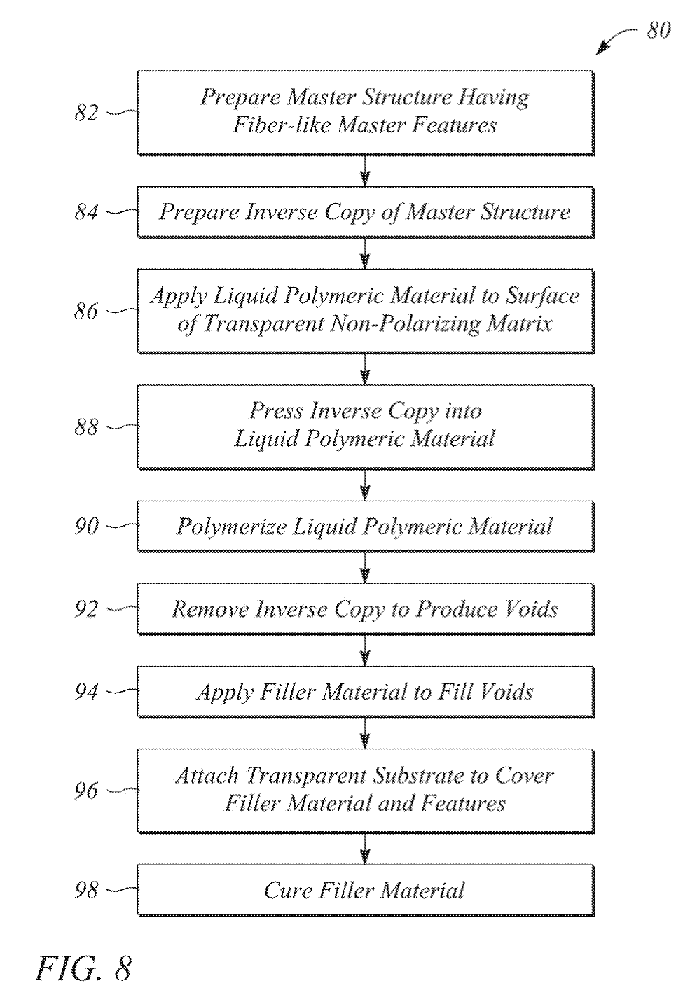

In some embodiments the method (80) of manufacturing some embodiments of a light diffuser involves the following procedure by way of illustration and not limitation. Referring to the flow chart of FIG. 8, a master structure is prepared (82) wherein the master structure has fiber-like features protruding from a surface of a substrate. The fiber-like features of this master structure may be prepared to comprise variations in one or both of a longitudinal cross-sectional dimension and a horizontal cross-sectional dimension. Such features may be prepared by the design of a mask and/or using a reflective substrate and a positive resist, for example. In some embodiments, for example, features as depicted in FIG. 3 can be made by using a reflective substrate (such as, e.g., silicon) and a positive resist. Exposure to UV through the mask in contact with the resist renders exposed areas soluble in a developer. UV reflects from the substrate and interferes with the incident light. The interference gives standing waves yielding layers of high and low UV exposure in the resist. Upon developing the resist, features with a profile similar to that of FIG. 3 may be made. In some embodiments, for example, features such as depicted in FIG. 4 can be defined by the design of the mask.

See, for example, Applied Physics Letters, 92, 223109 (2008), which describes employing photolithographic standing wave corrugations as nanoscale templates. As the process is described by the authors, optical standing waves are established during the monochromatic, normal incidence illumination of a photoresist film and are the product of interference between the incident wave and its reflection from a substrate surface. The interference pattern distributes optical energy within the photoresist into vertically stacked planes of alternating high and low energy which, once the photoresist is developed, serves to add regular structure along the substrate normal, orthogonal to the plane of the transferred pattern. These corrugations are typically associated with reduced line-width resolution and as a result are routinely suppressed with antireflection coatings and post-exposure bakes.

An inverse copy of the aforementioned master structure is prepared (84) using a cured resin. In some embodiments a liquid resin such as, for example, polydimethylsiloxane (PDMS), is poured onto the surface of the master structure and left to harden to form a flexible inverse copy of the master structure, which may be referred to as a stamp. Embodiments of the present light diffuser may be prepared from this stamp. In some embodiments a layer of liquid resin is applied (86) to a surface of a transparent support layer and the stamp is pressed (88) into the liquid resin on the surface. The resin fills the voids of the stamp and is subsequently hardened by a suitable technique such as, for example, application of radiation, e.g., UV light, or application of heat, to achieve polymerization (90). The stamp is then removed (92) to leave a copy of the original master structure. A filler is applied (94) to the support layer to fill the voids between the fiber-like features. A transparent substrate is attached (96) to the assembly to cover the filler and the fiber-like features. Depending on the nature of the filler, a process for curing (98) the filler may be employed such as, for example, in the case of a liquid resin. In some embodiments a light diffuser in accordance with the present invention comprises a support layer that is transparent and non-polarizing, a plurality of fiber-like features disposed in a two-dimensional array on a surface of support layer, and a filler disposed between the features, the filler having a refractive index different from a refractive index of the features. The features are a polymeric solid or a liquid, have a longitudinal axis and are substantially parallel to one another. When the features are a polymeric solid, at least one feature of the plurality comprises at least one predetermined variation in one or both of a longitudinal cross-sectional dimension and a horizontal cross-sectional dimension. When the features are liquid, filler is substantially solid. In some embodiments of the above, the light diffuser also comprises a transparent substrate where the features and the filler are sandwiched between the support layer and the transparent substrate. In some embodiments the transparent substrate is non-polarizing.

In some embodiments the manufacture of diffuser 20 is as illustrated in FIG. 5C. In these embodiments a filler structure is first formed having voids between the filler. The filler structure may be formed by patterning a photoresist to obtain a structure having walls with cavities or voids between the walls. The voids are subsequently filled with a liquid material that forms liquid fiber-like features. An embodiment of the formation of the filler structure with hexagonal walls is discussed below in Example 2. A liquid material is added to the voids to form the fiber-like features. FIG. 5C illustrates solid filler walls 26 on surface 23 of support layer 22 with voids 25 between the filler walls 26. Following the creation of the filler walls 26, a suitable liquid is introduced into the voids to form fiber-like features 24 on support layer 22. Then, transparent substrate 28 is placed over the filler walls to complete the preparation. In some embodiments the liquid may be a curable material in which case curing results in solid polymeric features.

In some embodiments a light diffuser comprises a support layer that is transparent and non-polarizing, a plurality of polymeric fiber-like features disposed in a two-dimensional array wherein the features extend from a surface of the support layer, and a filler disposed between the features. The filler has a refractive index different from a refractive index of the features. The features have a longitudinal axis and are substantially parallel to one another. At least one feature of the plurality comprises at least one predetermined variation in one or both of a longitudinal cross-sectional dimension and a horizontal cross-sectional dimension.

A light diffuser in accordance with the present embodiments may be employed in a visual image display apparatus. In some embodiments the light diffuser is employed in reflective displays. The reflective displays include, for example, absorption mode reflective displays, scattering reflective displays, selective reflection reflective displays. In some embodiments the display apparatus is a guest-host liquid crystal reflective display. The display apparatus comprises an electro-optic layer, a reflector that reflects light received from the rear of the electro-optic layer back through the electro-optic layer and an embodiment of the present light diffuser in front of the electro-optic layer. The electro-optic layer in embodiments of a guest-host liquid crystal reflective display may comprise a liquid crystal material that contains a dye or pigment (e.g., dichroic dye) whose optical absorption properties vary depending on its orientation. When an electric field is applied to the device, the orientation of the liquid crystal material changes, light is absorbed by the dye and the displayed color changes.

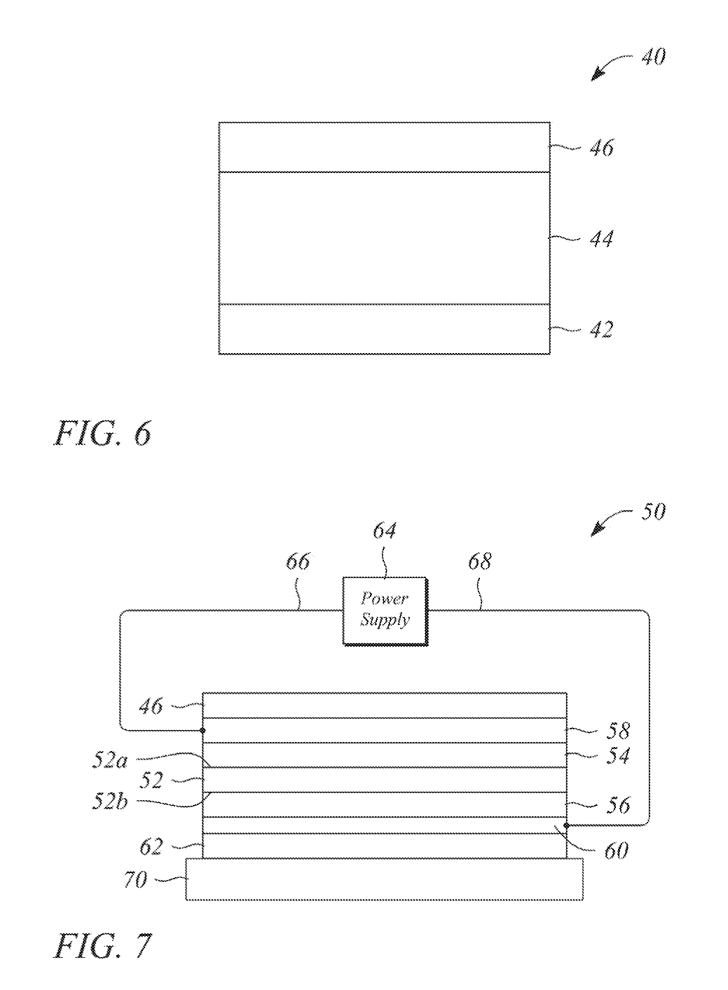

An embodiment of a visual image display apparatus that is a reflective display and that comprises an embodiment of a light diffuser in accordance with an embodiment of the present invention is depicted in FIG. 6 by way of illustration and not limitation. Visual image display apparatus 40 comprises reflector 42 having disposed thereon electro-optic layer 44 and light diffuser 46, that may be any of the embodiments of the light diffuser described herein. The reflector reflects light received from a rear of the electro-optic layer back through the electro-optic layer. The light diffuser 46 is positioned in front of the electro-optic layer 44.

Visual image display apparatus that comprise an embodiment of the present light diffuser may also comprise other elements in addition to a reflector and an electro-optic layer. Examples of other elements include one or more electrodes, one or more orientation layers, liquid crystal, optical waveplates, optical filters, for example.

Referring to FIG. 7, in another embodiment of a visual image display apparatus 50 that comprises an embodiment of a light diffuser in accordance with an embodiment of the present invention, the electro-optic layer is a liquid crystal layer 52 having a first surface (or front surface) 52a and a second surface (or a rear surface) 52b. A first (or front) orientation layer 54 is disposed adjacent the front surface 52a of liquid crystal layer 52 and a second (or rear) orientation layer 56 is disposed adjacent rear surface 52b of liquid crystal layer 52. A first (or front) transparent electrode 58 is adjacent front orientation 54 layer and a second (or rear) transparent electrode 60 is adjacent rear orientation layer 56. The apparatus also includes a reflector 62 that reflects light received from behind the liquid crystal layer back through the liquid crystal layer. An embodiment of the present light diffuser 46 is disposed in front of the liquid crystal layer. Each of electrodes 58 and 60 is respectively connected to power supply 64 by means of lines 66 and 68. Power supply 64 is designed to separately activate electrode 58 and electrode 60. Reflector 62 is disposed on support 70.

### Definitions:

The following provides definitions for some of the terms and phrases used above, which were not previously defined.

The phrase “at least” as used herein means that the number of specified items may be equal to or greater than the number recited. The phrase “about” as used herein means that the number recited may differ by plus or minus 10%; for example, “about 5” means a range of 4.5 to 5.5. The designations “first” and “second” as used herein do not imply any order of importance or any particular sequence. The designations “front” and “rear” as used herein denote relative positions of one item to another such as the position of a viewer relative to the position of a display where the front of the display would be viewed by the viewer, or the position of one item of a display relative to another item of a display with reference to the position of a viewer. Moreover, examples herein are intended to be illustrative only and are presented for discussion purposes and not by way of limitation.

### EXAMPLE

### Example 1

A master structure is prepared using photolithography. A glass substrate is coated with SU-8 photoresist (Microchem Corp., Newton Mass., USA) using spin coating. The thickness of the film controls the thickness of the final features. In this example, 25 micron long features are achieved by spin coating SU-8 2025 at 4000 rpm. The resist is processed as per the manufacturer's instructions. A soft bake is conducted at 95° C. for 5-6 minutes prior to exposing the resist to UV light through a mask to define the features. The exposure dose is 150-160 mJ/cm² at a wavelength of 365 nm. The mask is made from a transparent substrate with opaque metal features. Since SU-8 is a negative resist, the mask is opaque with transparent regions that correspond to the fiber-like features. The exposed resist remains and, thus, the mask has an array of clear apertures, the diameter of which determines the diameter of the fiber-like features.

After exposure, the resist is baked on a hotplate at 95° C. for 5-6 minutes and the resist is then developed using immersion development in a solvent such as ethyl lactate. The development times are 4-5 minutes. The surface is then rinsed in isopropyl alcohol (IPA) and is dried with filtered pressurized air. The structure is then hard baked at 150 to 250 ° C. for between 5 and 30 minutes. This process forms robust master structures, from which a stamp can be made.

A PDMS silicone elastomer such as Sylgard 184 (Dow Corning) is used to make the stamp. This is a two-part resin, typically mixed with 10 parts base resin to 1 part cure agent. It is poured onto the SU-8 surface and left to cure in a 70° C. oven for 17 hours. After this time, it is peeled away from the master. The master is left undamaged and can be used a number of times.

The stamp contains an inverse impression of the SU-8 fiber-like features and is used to form a replica of the master by imprinting in a UV curable resin. The liquid resin is spread onto the surface of the transparent support layer and the stamp is gently pressed into the surface, expelling excess resin. The stamp is then exposed to UV radiation with a sufficient dose to fully cure the resin resulting in a solid polymer. The stamp can then be gently removed from the cured resin, leaving a copy of the fiber-like features on the surface of the support layer with voids between the fiber-like features. The stamp can be used a number of times. The UV curable resin employed contains acrylate components with the formulation designed to give the required refractive index and physical properties. A typical example is given by Se-Jin Choi, et al., in J. Am. Chem. Soc. 2004, vol 126, pages 7744-7745 and the associated supporting information.

To make an embodiment of the present diffuser, a filler is applied to the surface of the fiber-like features and the final transparent substrate is applied and the filler fills the voids between the fiber-like features. The filler is another UV curable acrylate-based resin, formulated to have a different refractive index than that employed above. Alternatively, the filler is a commercially available UV optical adhesive, examples of which are available with well defined refractive indices, such as those from Norland Products Inc., Cranbury N.J., USA. A layer of the resin is applied to the fiber-like features and the transparent substrate laminated onto the top. The structure is then exposed to UV to cure the resin, which also then adheres to the substrate on to the top of the diffuser assembly.

### Example 2

Preparation of Polymeric Filler Substrate: A glass substrate is spin-coated with layer of chrome having a thickness of 100 nm. A coating of thin resist (Shipley s1805, Shipley Company, Marlborough Mass.) is applied to the chrome layer. The resist layer is exposed to light through a mask to leave a regular array of resist hexagons. The exposed chrome is etched away using a liquid chrome etch solution to leave an array of chrome hexagons. Then, the resist is removed using a standard resist stripper or a solvent (e.g., acetone). The surface of the chrome is coated with a layer of SU8-2010 photoresist (Microchem, USA) spun at 1000 rpm to obtain a thickness of about 30 microns. The layer is exposed through the back of the substrate using the chrome as a mask in contact with the SU8-2010 and is developed according to standard techniques. An array of hexagonal polymer walls is obtained with voids therebetween (see FIG. 5C).

Preparation of Light Diffuser: The voids between the hexagonal polymer walls in the above array are filled with a high index liquid (diiodomethane) to form fiber-like features and a transparent substrate is fixed on the top of the structure and the edges are sealed with an adhesive.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims. Furthermore, the foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Many modifications and variations are possible in view of the above teachings. The embodiments were chosen and described in order to explain the principles of the invention and its practical applications and to thereby enable others skilled in the art to utilize the invention.

What is claimed is:

1. A light diffuser (20, 46) comprising a plurality of fiber-like features (24) disposed in a filler (26) in a two-dimensional array wherein the features (24) have a longitudinal axis and are substantially parallel to one another and wherein a refractive index of the features (24) is different from a refractive index of the filler (26) and wherein the features (24) are either
(i) a polymeric solid wherein at least one feature (24) of the plurality comprises at least one predetermined variation in one or both of a longitudinal cross-sectional dimension and a horizontal cross-sectional dimension or
(ii) a liquid wherein the filler (26) is substantially solid.

2. The light diffuser (20, 46) according to claim 1 further comprising a support layer (22) on which fiber-like features (24) are disposed wherein the longitudinal axis of the features (24) is substantially normal to a surface (23) of the support layer (22).

3. The light diffuser (20, 46) according to claim 1 wherein the filler (26) is selected from the group consisting of resins, air and oils.

4. The light diffuser (20, 46) according to claim 1 wherein the fiber-like features (24) have a shape and a length such that light impinging on the light diffuser (20, 46) at an angle is diffused into a hollow cone centered about a normal to the light diffuser (20, 46).

5. The light diffuser (20, 46) of claim 1 wherein the at least one predetermined variation is in a longitudinal cross-sectional dimension and the cross-sectional shape of the features (24) is circular.

6. The light diffuser (20, 46) of claim 1 wherein the at least one predetermined variation is in a horizontal cross-sectional dimension and the cross-sectional shape of the features is triangular, square, quadrangular, hexangular, oval, scalloped, corrugated, ellipsoidal, or star-shaped with different numbers of vertices.

7. A visual image display apparatus (40) comprising a light diffuser (46) which comprises:
a transparent non-polarizing support layer (22) having disposed on a surface (23) thereof in a two-dimensional array a plurality of fiber-like features (24) that extend from the surface (23), wherein the features (24) have a longitudinal axis and are substantially parallel to one another;
a filler (26) disposed between the features (24), the filler (26) having a refractive index different from a refractive index of the features (24); and
a transparent substrate (28), wherein the features (24) and the filler (26) are disposed between the transparent substrate (28) and the support layer (22),
wherein the features (24) are a polymeric solid or a liquid with the proviso that the filler is substantially solid when the features (24) are liquid and with the proviso that at least one feature (24) of the plurality comprises at least one predetermined variation in one or both of a longitudinal cross-sectional dimension and a horizontal cross-sectional dimension when the features (24) are a polymeric solid.

8. The visual image display apparatus (40) according to claim 7 wherein the features (24) have a shape and a length such that light impinging on the light diffuser (46) at an angle is diffused into a hollow cone centered about a normal to the light diffuser (46).

9. The visual image display apparatus (40) according to claim 7 wherein the filler (26) is selected from the group consisting of resins, air and oils.

10. The visual image display apparatus (40) according to claim 7 further comprising an electro-optic layer (44) having a first side and a second side and a reflector (42) that reflects light received from the second side of the electro-optic layer (44) back through the electro-optic layer (44) and wherein the light diffuser (46) is disposed on the first side of the electro-optic layer (44).

11. The visual image display apparatus (40) according to claim 7 wherein an average diameter of the fiber-like features (24) is less than about 100 microns.

12. The visual image display apparatus (40) according to claim 7 wherein the electro-optic layer (44) is selected from the group consisting of liquid crystal displays, dichroic guest host displays, electro-wetting displays, electrophoretic displays, cholesteric displays and microelectromechanical-based displays.

13. A method (80) of making a light diffuser (20, 46), the method comprising:
(a) preparing (82) a master structure wherein the master structure has a plurality of fiber-like master features extending from a surface of a substrate, the features having a longitudinal axis and being substantially parallel to one another, at least one feature of the plurality comprising at least one predetermined variation in one or both of a longitudinal cross-sectional dimension and a horizontal cross-sectional dimension;
(b) preparing (84) an inverse copy of the master structure;
(c) applying (86) a liquid polymer-precursor material to a surface of a transparent non-polarizing support layer;
(d) pressing (88) the inverse copy of the master structure into the liquid polymer-precursor material;
(e) polymerizing (90) the liquid polymer-precursor material to form a solid polymer of a plurality of the features on the surface of the support layer;
(f) removing (92) the inverse copy of the master structure to produce voids between the features;
(g) applying (94) a filler material to fill the voids; and
(h) attaching (96) a transparent substrate to cover the filler material and the features.

14. The method (80) according to claim 13 further comprising, for a curable resin: (i) curing (98) the filler material.

15. The method (80) according to claim 13 wherein the at least one predetermined variation is in a longitudinal cross-sectional dimension and the cross-sectional shape of the features is circular or wherein the at least one predetermined variation is in a horizontal cross-sectional dimension and the cross-sectional shape of the features is polygonal, oval, scalloped, corrugated, ellipsoidal, or star-shaped.
